(19) United States
(12) Patent Application Publication
(10) Pub. No.: US 2006/0037441 A1
(43) Pub. Date: Feb. 23, 2006

(54) Method for fabrication of electrophotographic cylinder cores

(75) Inventors: Steven O. Cormier, West Henrietta, NY (US); Edward T. Miskinis, Rochester, NY (US); Dennis Grabb, Sodus, NY (US)

Correspondence Address: Lawrence P. Kessler;Patent Legal Staff, Eastman Kodak Company, 343 State Street, Rochester, NY, 14650-2201, US

(73) Assignee: Eastman Kodak Company

(21) Appl. No.: 10/921,738

(22) Filed: Aug. 19, 2004

(51) Int. Cl. B23B 3/00

(52) U.S. Cl. 82/1.11

(57) ABSTRACT

This invention relates to a method for economically and efficiently producing cores for use in the production of an image cylinder or a blanket cylinder for use in an electrophotographic process.

### FIELD OF THE INVENTION

This invention relates to a method for economically and efficiently producing cores for use in the production of an image or a blanket cylinder for use in an electrophotographic process.

### BACKGROUND OF THE INVENTION

In electrophotographic processes requiring an image cylinder and a blanket cylinder to produce electrophotographic copies, the image cylinder typically receives a charge, an image and a toner coating on the image area and then transfers the toner image to a blanket cylinder. The blanket cylinder transfers the toner image to a substrate such as paper or the like which passes via a web between the blanket cylinder and a back pressure roller to transfer the toner image to the substrate with the substrate thereafter being fused as well known to those skilled in the art. In such processes, the image cylinder includes a mandrel, which may be of aluminum, steel or any other suitable metal or conductive plastic of a suitable thickness to produce a non-compliant member, which may be about 10 millimeters (mm) in thickness. The mandrel may include reinforcing structure internally and includes a very smooth low, out of round exterior. The image cylinder includes a mandrel and a sleeve positioned over the outside of the mandrel and is used for production and transfer of images to the blanket cylinder. The mandrel also includes bearings positioned at each of its ends for positioning in an electrophotographic copying machine and has an air inlet into the interior of the mandrel for an air discharge through a plurality of holes positioned around one end of the mandrel and near a tapered end of the mandrel.

Sleeves may be produced by the use of a metal core as a substrate for a smoothing layer, a charge generation layer and optionally other layers which may be used to produce the outer surface of the image cylinder which is capable of accepting a light image and converting it into a charge image which is then conveyed to the blanket cylinder for subsequent transfer to a substrate.

Desirably the metal core must be seamless and must provide a very low variation surface outer diameter. The electrophotographic coatings have been applied by techniques such as ring coating, dip coating and the like. The completed sleeve will have an internal diameter slightly less than the outer diameter of the mandrel upon which it is to be placed. This interference fit allows the sleeve to be firmly positioned on the outside of the mandrel after it is installed. The sleeve must have a smooth exterior and a closely controlled outer diameter variation over its length.

The sleeve is typically installed by urging it toward and onto the tapered end section of a mandrel while air is injected through the holes at the end of the mandrel near the tapered section. The air injection permits the positioning of the sleeve on the mandrel by air step techniques as known to those skilled in the art. The interference fit between the sleeve and the mandrel is accomplished and the sleeve is retained snugly and firmly in position on the outside of the mandrel. The sleeve must have an outside diameter variation along its length within a range of about +/−12.5 microns. This close tolerance is necessary to ensure accurate transmission of images to the blanket cylinder.

There are various other specific requirements for the image cylinder and it has previously been considered necessary to meet those requirements by, in many instances, either attempting to very precisely produce the metal core by plating, by precision machining and the like. The requirement for precision machining is difficult since the core is relatively thin. These are expensive steps but are considered necessary to produce metal cores having the required tolerances without imperfections, such as nodules, lumps, pits or other variations on the surface.

Accordingly, a continued effort has been directed to the development of less expensive methods for producing precise outer diameter image cylinder sleeves.

### SUMMARY OF THE INVENTION

The present invention provides a method for producing precise outer diameter image and blanket cylinder sleeve cores of constant inner diameter from imprecise thin-walled seamless tubing, the method comprising: placing a length of the imprecise thin-walled tubing on a mandrel in intimate contact with the mandrel; machining the length of tubing to produce a precise outer diameter core; and, removing the precise outer diameter core from the mandrel.

### BRIEF DESCRIPTION OF THE DRAWINGS

FIG. 1 is a schematic diagram of a prior art image cylinder;

FIG. 2 is a schematic diagram of a mandrel, according to the present invention; and

FIG. 3 is a schematic diagram of a longitudinal section of a sleeve positioned on a mandrel for machining.

### DESCRIPTION OF PREFERRED EMBODIMENTS

In the discussion of the Figures, the same numbers will be used throughout to refer to the same or similar components.

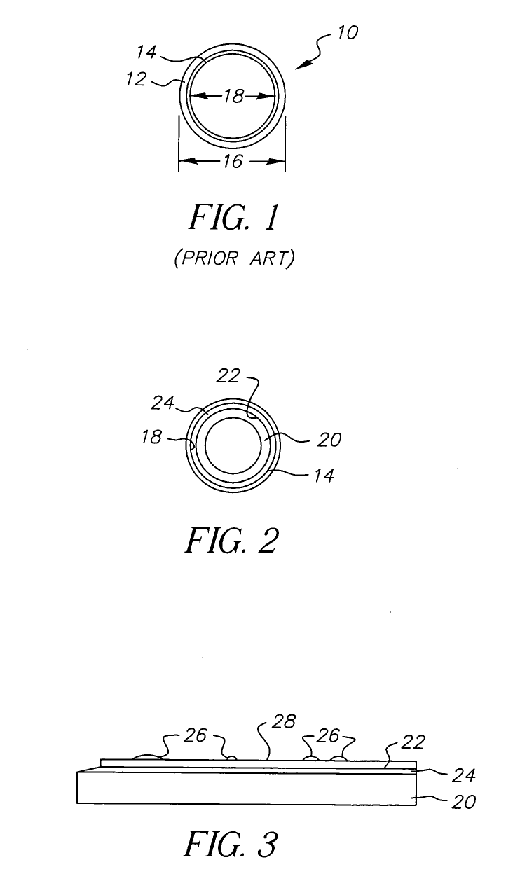

In FIG. 1, a schematic diagram of an image cylinder 10 is shown. Image cylinder 10 includes an outer layer 12 having the electrophotographic components necessary for the functioning of the image cylinder. The image cylinder also includes an inner metal core 14, which is desirably of a selected diameter to result in the production of the desired outer diameter sleeve when the image cylinder sleeve is positioned on a mandrel 20.

As discussed above, the metal core is generally slightly undersized relative to the outer diameter of the mandrel. The metal core bearing the electrophotographic component layers is urged onto the mandrel by the use of an air step technique that results in positioning the metal core over the mandrel with a very intimate, firm fit so that the core remains fixed in place until it is desired to remove it. Such techniques are well known to those skilled in the art.

In FIG. 2, mandrel 20 is shown, according to the present invention, for use in machining the metal sleeve. The mandrel includes a core 14 positioned around an outer diameter 22 of the mandrel. An inner diameter 18 of the core is generally slightly less than the outer diameter 22 of the mandrel. The mandrel includes a compliant layer 24 on its outside, which may be of any suitable material. The material is desirably selected from materials such as urethanes, rubbers and the like. A wide variety of materials are suitable for this purpose provided they have a suitable firmness. Desirably, the materials have a Durometer hardness from about 45 to about 110 and preferably from about 60 to about 100.

The mandrel is formed to have a relatively uniform outside diameter, i.e., a variation of no more than +/−12.5 microns along its length. The core constituents of the mandrel may be constructed of aluminum, stainless steel or any other suitable metal or conductive plastic of a suitable thickness. The sleeve as mounted on the mandrel is positioned for machining.

According to the present invention, the starting material for the production of the sleeve can be materials produced with much less precision than previously considered necessary. Such materials may include thin-walled tubes made by extrusion, flow forming, electroforming or any other method that produces seamless tubes. The tube typically does not have the required low tolerances, especially on its exterior for use as a core for a blanket cylinder or an image cylinder. While the inner diameter is typically of a suitable consistency and uniformity for positioning over the mandrel, the outside does not meet the exacting requirements for smoothness and small variation along the length of the core.

Accordingly, the sleeve which may include of any suitable material such as aluminum, nickel, stainless steel, copper, chromium, plastic and the like is desirably placed over the mandrel and then machined to produce a precise diameter sleeve. The machining can be accomplished by means known to those skilled in the art, such as the use of a diamond turning tool and the like. Since the sleeves are relatively thin, the presence of nodules, bumps and the like on the sleeve can result in sudden snagging of the bump by the turning tool with resulting rupture of the thin material. Further, the cutting tool may as it moves over the projection be deflected into cutting undesirable material from other sections of the sleeve.

To achieve desirable results, it has been found that the outer surface of the mandrel should have the resilience provided by the outer surface having a Durometer hardness from about 45 to about 110. By the use of this flexible material, the core is able to deform allowing the cutting tool to remove thin slices of the protruding material without affecting the surrounding layer of material that maybe within specifications. Desirably, the outer core diameter is uniform and has a variation of no more than +/−12.5 microns along its length.

As shown in FIG. 3, the core includes projections 26 and a depression 28. Desirably the sleeve material is machined to a consistent thickness of precise uniformity. This provides a suitable surface for the installation of additional layers such as a smoothing layer, a barrier layer, an electric charge generation layer, a transportation layer and optionally other layers if considered necessary to provide a film of layers capable of generating an image from a light source.

The use of the resilient material permits the machining operation to proceed using materials that would not previously have been considered suitable for the production of cores. This results in a substantial economic benefit in the overall production process. The outer surface of the mandrel, however, must be of suitable hardness so that the core is maintained firmly in place and so that the inner diameter of the core is of a suitable diameter for installation on a mandrel in a machine.

A further advantage of the present process is that the inside diameter of the core produced on a particular mandrel will be constant rather than including variations resulting from the production process when the process includes plating, machining the inner and outer surface of the tube and the like.

Typically imprecise thin-walled tubing having surface variations greater than about 100 microns from the average outer surface diameter of the imprecise sleeve may be used. After machining the thin-walled tubing has been converted into a core having an outer diameter of less than about +/−12.5 microns from the average outer diameter. The starting thin-walled tubing may have a variation greater than about +/−12.5 microns from the average outer diameter of the sleeve. Desirably, the finished core has a wall thickness from about 75 to about 700 microns

As previously noted, the outer surface of the machining mandrel may be of materials such as urethane or rubber having the desired Durometer hardness. Desirably the thickness of the coating material on the machining mandrel outer surface is from about 0.5 to about 14 mm for each material. More desirably, the thickness is from about 0.5 to about 10 mm.

By the method of the present invention, cores are readily produced for image cylinders using as a starting material thin walled tubing which has an imprecisely controlled outer surface and uniformity and an imprecisely controlled diameter variation along its length.

This technique is useful for the production of cores for blanket cylinders and image cylinders, although the quality requirements for blanket cylinders are somewhat less rigid than for the image cylinders. It is still desirable to produce high quality cores for the blanket cylinder.

While the present invention has been described by reference to certain of its preferred embodiments, it is pointed out that the embodiments described are illustrative rather than limiting in nature and that many variations and modifications are possible within the scope of the present invention. Many such variations and modifications may be considered obvious and desirable by those skilled in the art based upon a review of the foregoing description of preferred embodiments.

What is claimed is:

1. A method for producing precise outer diameter image cylinder cores of constant inner diameter from imprecise thin-walled seamless tubing, the method comprising:
a) placing a length of the imprecise thin-walled tubing on a mandrel in intimate contact with the mandrel;
b) machining the length of tubing to produce a precise outer diameter sleeve; and
c) removing the precise outer diameter core from the mandrel.

2. The method of claim 1, wherein the core comprises at least one of aluminum, nickel, copper, stainless steel, chromium and plastic.

3. The method of claim 1, wherein the mandrel comprises at least one of aluminum, nickel, stainless steel, copper, chromium and plastic.

4. The method of claim 1, wherein the mandrel has an outer surface having a Durometer hardness from about 45 to about 110.

5. The method of claim 4, wherein the Durometer hardness is from about 60 to about 100.

6. The method of claim 4, wherein the outer surface of the mandrel comprises polyurethane.

7. The method of claim 4, wherein the outer surface of the mandrel comprises rubber.

8. The method of claim 4, wherein the outer surface comprises a layer of polyurethane from about 0.5 to about 14 mm in thickness.

9. The method of claim 8, wherein the thickness is from about 0.5 to about 10 mm.

10. The method of claim 4, wherein the outer surface comprises a layer of rubber from about 0.5 to about 14 mm in thickness.

11. The method of claim 10, wherein the thickness is from about 0.5 to about 10 mm.

12. The method of claim 1, wherein the core of imprecise thin-walled tubing has an outer surface variation greater than +/−12.5 microns from the average outer surface diameter of the imprecise thin-walled tubing.

13. The method of claim 1, wherein the precise outer diameter core has an outer surface diameter variation of less than +/−12.5 microns from the average outer surface diameter of the precise outer diameter core.

14. The method of claim 1, wherein the imprecise length of thin-walled tubing has an outer diameter variation along its length greater than +/−12.5 microns.

15. The method of claim 1, wherein the precise outer diameter core has an outer surface diameter variation along its length of less than +/−12.5 microns.
